(19) United States
(12) Patent Application Publication
(10) Pub. No.: US 2004/0199800 A1
(43) Pub. Date: Oct. 7, 2004

(54) POWER MANAGEMENT SYSTEM OF A PORTABLE COMPUTER

(76) Inventors: Chien-Chih Yu, Taipei Hsien (TW); Kuan-Chi Juan, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,006

(22) Filed: Aug. 31, 2003

(30) Foreign Application Priority Data
Apr. 4, 2003 (TW) 092205375

(51) Int. Cl. G06F 1/26; G06F 1/32

(52) U.S. Cl. 713/320

(57) ABSTRACT

A power management system for controlling power of a portable computer has an AC/DC adapter, a current sensor for sensing an output current of the AC/DC adapter, a comparator for comparing the output current with a reference current, and a logic circuit. If the output current is greater than the reference current, the comparator outputs an alarm signal. The logic circuit analyzes the alarm signal. If the alarm signal conforms to a predetermined standard, the logic circuit controls operations of the portable computer to reduce the power of the portable computer received from the AC/DC adapter.

### BACKGROUND OF INVENTION

1. Field of the Invention

The present invention relates to a power management system, and more specifically, to a power management system for controlling the power of a portable computer. Therefore, a maximum transient power consumption of the portable computer is smaller than a predetermined power.

2. Description of the Prior Art

Due to the advancement of electrical technology, many electric products have more variable functions and smaller sizes. The most obvious example is that desktop computers are gradually replaced by portable computers, therefore, portable computers are often the first choice of personal computers for users. A portable computer generally comprises an AC/DC adapter for providing electric components installed in the portable computer with power, and an overload protection design is usually used for protecting the portable computer from being damaged due to an exceeding power consumption. However, as a working frequency of the portable computer system improves, a power consumption required by the portable computer relatively increases. For a proper operation of the portable computer, an AC/DC adapter that is able to provide more power is required. Please refer to FIG. 1, which is a time sequence diagram of system power consumption of a prior art portable computer, and shows a transient power consumption of the portable computer with an improved working frequency. Therein, the x-axis indicates time, and the y-axis indicates system power consumption of the portable computer. The maximum power provided by the AC/DC adapter is noted as P_{MAX}, and before improving the working frequency of portable computer, the maximum power P_{MAX} is sufficient for the system power consumption of portable computer. After improving the working frequency, the transient power consumption of the portable computer is generally less than P_{MAX}. However, when implementing certain programs or implementing too many programs at the same time, the transient power consumption of the portable computer possibly exceeds the maximum power P_{MAX} provided by the AC/DC adapter. Consequently, the portable computer becomes unstable, or triggers the mechanism of the overload protection design for shutting down the portable computer. For example, during the time period from T1 to T2 shown in FIG. 1, the transient power consumption exceeds P_{MAX} of the AC/DC adapter. Therefore, when a central processing unit (CPU) with a higher working frequency is used for replacing a CPU of a lower working frequency so as to upgrade the portable computer, the portable computer usually becomes unstable because the maximum power consumption of the portable computer increases and exceeds the maximum power provided by the original AC/DC adapter. When that happens, the overload protection design triggers the computer to shutdown unexpectedly, which renders users clueless of what just happened.

Therefore, the AC/DC adapter providing DC voltage also has to be replaced after upgrading the portable computer so as to prevent an overload of the upgraded portable computer. However, the size of the AC/DC adapter is in proportion to its maximum providing power, that is, the AC/DC adapter that is able to provide more power usually has a bigger size. Furthermore, a space in the portable computer for installing the AC/DC adapter is fixed, so it is difficult to find another proper AC/DC adapter for the upgraded portable computer. Even if a proper AC/DC adapter is obtained, the cost of upgrading the portable computer will increase for buying an additional AC/DC adapter.

For manufacturers of portable computers, because a working frequency of the portable computer is improving, AC/DC adapters of different standards are required for corresponding to each portable computer. Consequently, for the manufacturers, the cost of production management and reserving products is substantially increasing.

### SUMMARY OF INVENTION

It is therefore a primary objective of the claimed invention to provide a power management system so as to solve the above-mentioned problem. Because the maximum power required by the portable computer is less than the maximum power provided by the AC/DC adapter in most time, the power management system of the claimed invention prevents the portable computer from being unstable or shutting down unexpectedly by reducing a working frequency of a CPU or a clock of a bus only when detecting the transient power consumption of the portable computer exceeds the maximum power provided by the AC/DC adapter.

According to the preferred embodiment of the claimed invention, the power management system for controlling power of a portable computer has an AC/DC adapter, a current sensor electrically connected to the AC/DC adapter for sensing an output current of the AC/DC adapter, a comparator electrically connected to the current sensor for comparing the output current with a reference current, and a logic circuit. If the output current is greater than the reference current, the comparator outputs an alarm signal. The logic circuit analyzes the alarm signal. If the alarm signal conforms to a predetermined standard, the logic circuit controls operations of the portable computer to reduce the power of the portable computer received from the AC/DC adapter.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a time sequence diagram of system power consumption of a prior art portable computer.

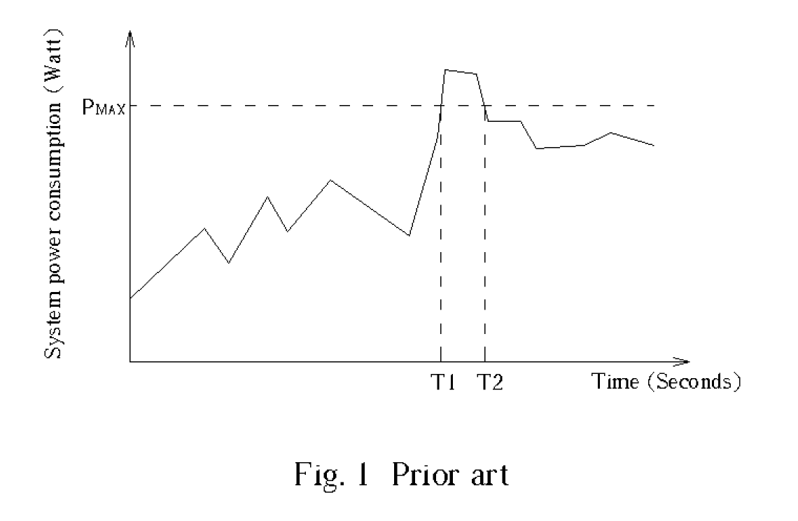

FIG. 2 is a functional block diagram of a power management system for a portable computer according to the present invention.

### DETAILED DESCRIPTION

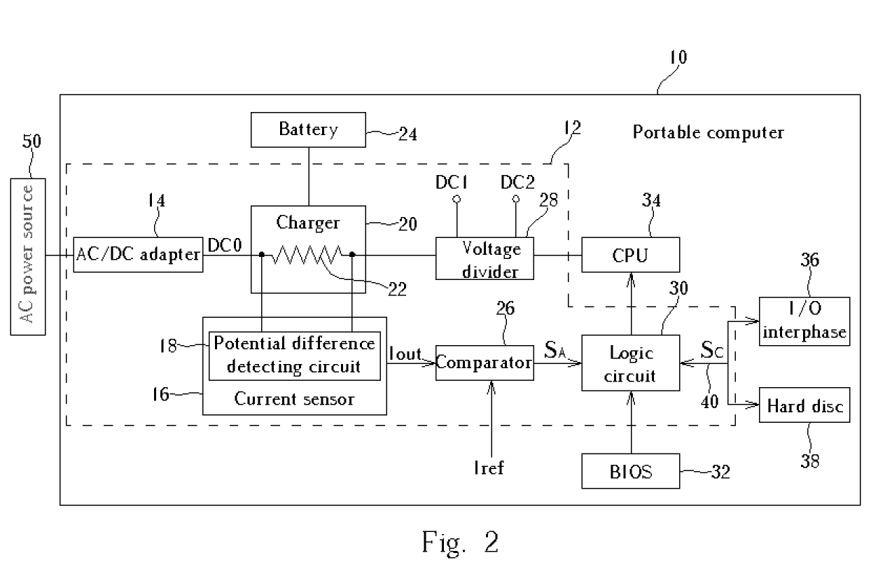

Please refer to FIG. 2, which is a functional block diagram of a power management system 12 for a portable computer 10 according to the present invention. The power management system 12 installed in the portable computer 10 comprises an AC/DC adapter 14, a current sensor 16, a comparator 26, and a logic circuit 30. The portable computer 10 further comprises a charger 20, a battery 24, a voltage divider 28, a basic input/output system (BIOS) 32, a central processing unit (CPU) 34, an input/output interface 36, a hard disc 38, and a bus 40. Therein, the AC/DC adapter 14 is electrically connected with an AC power source 50 and is used for transforming AC voltage provided from the AC power source 50 to constant DC voltage DC0 so as to further provide the DC voltage DC0 to the portable computer 10. The voltage divider 28 is electrically connected with the AC/DC adapter 14, and a main function of the voltage divider 28 is transforming the output DC voltage DC0 of the AC/DC adapter 14 to a plurality of DC voltages DC1, DC2 . . . of different values and then applying DC1, DC2 . . . to different electric components of the portable computer 10. The charger 20 is used for charging a battery 24 when the portable computer 10 is in a standby state or a power saving mode. The input/output interface 36 could be a graphical interface, a network interface or a sound effects interface, which is used to communicate data to other devices (such as the hard disc 38) through the bus 40.

The charger 20 of a general portable computer comprises a sense resistor 22 for sensing currents flowing to the charger 20. Many related illustrations about the charger 20 and the sense resistor 22 are shown in prior technical references, such as US patent “High-efficiency Battery Charger” (U.S. Pat. No. 6,300,744). The current sensor 16 is electrically connected with the AC/DC adapter 14 and is used for sensing an output current I_{OUT} of the AC/DC adapter 14 flowing through the sense resistor 22. The current sensor 16 comprises a potential difference detecting circuit 18 connected in parallel with the sense resistor 22 for detecting the potential difference between two ends of the sense resistor 22 and reading the output current of the AC/DC adapter 16 through the resistance of the sense resistor 22. The comparator 26 is electrically connected with the current sensor 16 for comparing the output current I_{OUT} with a reference current I_{ref}. If the output current I_{OUT} is greater than the reference current I_{ref}, the comparator 26 outputs an alarm signal S_{A} to the logic circuit 30, and then the logic circuit 30 controls the operation of the portable computer 10 according to the alarm signal S_{A} so as to reduce the power of the portable computer 10 provided by the AC/DC adapter 14.

In the embodiment of the present invention, the square of the reference current I_{ref} multiplied by the resistance of the sense resistor 22 is slightly less then the maximum output power of the AC/DC adapter 14. Consequently, when the output current I_{OUT} is greater than the reference current I_{ref}, the transient power consumption of the portable computer 10 will possibly exceed the maximum output power of the AC/DC adapter 14. By means of the above-mentioned power management system 12, when the output current I_{OUT} is greater than the reference current I_{ref}, which causes the transient power consumption to exceed a predetermined power of the maximum load, the power of the portable computer 10 is reduced properly for preventing an unstable state or unexpected shut down due to an overload of the AC/DC adapter 14. Furthermore, the predetermined power of the maximum load is less than the maximum output power of the AC/DC adapter 14.

In the embodiment of the present invention, the logic circuit 30 is a keyboard mouse controller (KBC), which is a common circuit device installed in the portable computers. When users do not operate the portable computer through a mouse or a keyboard for a long time, the KBC is used to switch the portable computer to a power saving mode or an idle mode for saving the power consumption. For example, when the mouse or the keyboard of the portable computer 10 does not function during a predetermined period, the KBC 30 will decrease the working frequency of the CPU 34 of the portable computer 10 so as to reduce the power consumption of the portable computer 10. Besides the KBC, the logic circuit 30 also could be a south bridge chip or a circuit for controlling the power model of the portable computer 10. The logic circuit 30 is programmable, and when the logic circuit 30 functioning, a related program code is read out from the BIOS 32 and is implemented so as to analyze the alarm signal S_{A}. The logic determination of the logic circuit 30 can be modified by upgrading the program code of the BIOS 32. The logic circuit 30 analyzes the alarm signal S_{A} for checking whether the alarm signal S_{A} conforms to a predetermined standard so as to prevent error actions due to system noises. That is, only when the alarm signal S_{A} conforms to the predetermined standard, the logic circuit 30 outputs a control signal S_{C} for controlling the operation of the portable computer 10 so as to reduce the power of the portable computer 10 provided by the AC/DC adapter 14. For example, the logic circuit 30 periodically checks whether the alarm signal S_{A} keeps a high potential during a period of time (such as five seconds) according to a clock signal. If the alarm signal S_{A} keeps a high potential during the period of time, the logic circuit 30 outputs the control signal S_{C} for controlling the operation of the portable computer 10 so as to reduce the power of the portable computer 10 provided by the AC/DC adapter 14. Oppositely, if the alarm signal S_{A} does not keep a high potential during the period of time, the logic circuit 30 does not output the control signal S_{C}. By means of the analyzing method, error actions for noises of the logic circuit 30 are prevented. After that, when the output current I_{OUT} sensed by the current sensor 16 is less than the reference current I_{ref}, the alarm signal S_{A} is reduced from a high potential to a low potential, and the logic circuit 30 again controls the operation of the portable computer 10 for returning from the power saving mode to the original operation mode.

Generally speaking, the logic circuit 30 has a variety of methods for reducing the power of the potable computer 10 provided by the AC/DC adapter 14 by controlling the operation of the portable computer 10. The most common method is reducing the working frequency of the CPU 34 of the portable computer 10. Furthermore, the logic circuit 30 also reduces the power of the potable computer 10 provided by the AC/DC adapter 14 by reducing a clock of the bus 40 or a rotation rate of the hard disc 38 of the portable computer 10.

It is necessary to explain that the maximum transient power consumption of the portable computer 10 is defined under specific operation steps of software and hardware, and the maximum transient power consumption is not easily achieved by ordinary operation or it is only achieved in a short period of time. Therefore, the efficiency of the portable computer 10 is not affected even though the power management system 12 of the present invention reduces the output power of the AC/DC adapter 14 by decreasing the working frequency of the CPU 34 when the transient power consumption of the portable computer 10 exceeds the predetermined power of the maximum load. Additionally, the logic determination of the logic circuit 30 for analyzing the alarm signal S_{A} can be designed by users, and the potable computer 10 can have a good balance in all aspects of expanding, efficiency, power management and stability.

Comparing to power controlling mode of the prior art portable computer, the power provided by the AC/DC adapter is not sufficient for the maximum transient power consumption of the upgraded portable computer with a high working frequency, which causes the portable computer to be unstable or shut down unexpectedly. The power management system of the present invention detects a possible overload of the portable computer in advance so as to properly reduce the transient power consumption of the portable computer. Consequently, the portable computer comprising the power management system of the present invention has a capability of upgrading a CPU, a bus and a drawing chip of a higher frequency.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A power management system for controlling power of a portable computer comprising:
an AC/DC adapter for transforming AC voltage to constant DC voltage and providing the portable computer with the DC voltage;
a charger for charging a battery of the portable computer, the charger comprising a sense resistor electrically connected with the AC/DC adapter;
a current sensor comprising a potential difference detecting circuit connected in parallel with the sense resistor for detecting the potential difference between two ends of the sense resistor so as to read an output current of the AC/DC adapter;
a comparator electrically connected with the current sensor for comparing the output current of the AC/DC adapter with a reference current, and if the output current of the AC/DC adapter is greater than the reference current, the comparator outputting an alarm signal; and
a logic circuit electrically connected with the comparator for analyzing the alarm signal, and if the alarm signal conforms to a predetermined standard, the logic circuit controlling operations of the portable computer to reduce the power of the portable computer received from the AC/DC adapter.

2. The power management system of claim 1 further comprising a voltage divider, which is electrically connected with the AC/DC adapter and is used for transforming the output DC voltage of the AC/DC adapter to a plurality of DC voltages of different values.

3. The power management system of claim 1, wherein the logic circuit reduces the power of the portable computer received from the AC/DC adapter by reducing working frequency of a central processing unit (CPU) of the portable computer.

4. The power management system of claim 1, wherein the logic circuit reduces the power of the portable computer received from the AC/DC adapter by reducing a clock of a bus of the portable computer.

5. The power management system of claim 1, wherein the logic circuit reduces the power of the portable computer received from the AC/DC adapter by reducing a rotation rate of a hard disc of the portable computer.

6. The power management system of claim 1, wherein the portable computer comprises a basic input/output system (BIOS), and the logic circuit reads and implements a program code of the BIOS so as to analyze the alarm signal.

7. The power management system of claim 1, wherein the logic circuit is a keyboard mouse controller (KBC).

8. The power management system of claim 1, wherein the logic circuit is a south bridge chip.

9. A power management system for controlling power of a portable computer comprising:
an AC/DC adapter for transforming AC voltage to constant DC voltage and providing the portable computer with the DC voltage;
a current sensor electrically connected with the AC/DC adapter for sensing an output current of the AC/DC adapter;
a comparator electrically connected with the current sensor for comparing the output current of the AC/DC adapter with a reference current, and if the output current of the AC/DC adapter is greater than the reference current, the comparator outputting an alarm signal; and
a logic circuit electrically connected with the comparator for analyzing the alarm signal, and if the alarm signal conforms to a predetermined standard, the logic circuit controlling operations of the portable computer to reduce the power of the portable computer received from the AC/DC adapter.

10. The power management system of claim 9, wherein the current sensor comprises a potential difference detecting circuit connected in parallel with a resistor of the portable computer for detecting the potential difference between two ends of the resistor so as to read the output current of the AC/DC adapter.

11. The power management system of claim 9, wherein the resistor is a sense resistor included in a charger of the portable computer, and the charger is used for charging a battery of the portable computer.

12. The power management system of claim 9 further comprising a voltage divider, which is electrically connected with the AC/DC adapter and is used for transforming the output DC voltage of the AC/DC adapter to a plurality of DC voltages of different values.

13. The power management system of claim 9, wherein the logic circuit reduces the power of the portable computer received from the AC/DC adapter by reducing a working frequency of a central processing unit (CPU) of the portable computer.

14. The power management system of claim 9, wherein the logic circuit reduces the power of the portable computer received from the AC/DC adapter by reducing a clock of a bus of the portable computer.

15. The power management system of claim 9, wherein the logic circuit reduces the power of the portable computer received from the AC/DC adapter by reducing rotation rate of a hard disc of the portable computer.

16. The power management system of claim 9, wherein the portable computer comprises a basic input/output system (BIOS), and the logic circuit reads and implements a program code of the BIOS so as to analyze the alarm signal.

17. The power management system of claim 9, wherein the logic circuit is a keyboard mouse controller (KBC).

18. The power management system of claim 9, wherein the logic circuit is a south bridge chip.
